(19) United States
(12) Patent Application Publication
(10) Pub. No.: US 2011/0213699 A1
(43) Pub. Date: Sep. 1, 2011

(54) Consumer-Managed Escrow Accounts

(76) Inventor: Timothy P. Johnson, Pine Mountain, GA (US)

(21) Appl. No.: 12/890,842

(22) Filed: Sep. 27, 2010

Related U.S. Application Data
(60) Provisional application No. 61/246,146, filed on Sep. 27, 2009.

(51) Int. Cl. G06Q 40/00

(52) U.S. Cl. 705/39

(57) ABSTRACT

Disclosed is a method and system for a Consumer-Managed Escrow Account which provides for an account capable of serving as a repository of funds, held in trust, to be used on behalf of the consumer, which shall be disbursed at the consumer's discretion to a plurality of recipients based on the fulfillment of a condition, but from which the consumer has no direct means to access the funds for personal use.

### CROSS-REFERENCE TO RELATED APPLICATIONS

This application claims priority to U.S. Provisional Patent Application No. 61/246,146, filed Sep. 27, 2009, which is incorporated herein by reference in its entirety.

### STATEMENT REGARDING FEDERALLY SPONSORED RESEARCH OR DEVELOPMENT

Not applicable

### REFERENCE TO A “SEQUENTIAL LISTING,” A TABLE, OR A COMPUTER PROGRAM LISTING APPENDEX SUBMITTED ON A COMPUTER DISC

Not applicable

### REFERENCES SITED [REFERENCED BY] U.S. PATENT DOCUMENTS

| | | |
|---|---|---|
| 5,283,829 | February 1994 | Anderson |
| 5,465,206 | November 1995 | Hilt et al |
| 5,504,677 | April 1996 | Pollin |
| 5,778,067 | July 1998 | Jones et al |
| 5,893,080 | April 1999 | McGurl et al |
| 5,920,847 | July 1999 | Kolling et al |
| 6,044,362 | March 2000 | Neely |
| 6,070,150 | May 2000 | Remington et al |
| 6,078,907 | June 2000 | Lamm |
| 6,223,168 | April 2001 | McGurl et al |
| 7,184,989 | February 2007 | Hansen et al |
| 7,225,155 | May 2007 | Polk |
| 7,353,203 | April 2008 | Kriplani et al |
| 7,558,758 | July 2009 | McCarthy et al |
| 2002/0016769 | February 2002 | Ellen et al |
| 2002/0032653 | March 2002 | Schutzer |
| 2002/0087469 | July 2002 | Ganesan et al |
| 2004/0098328 | May 2004 | Grant et al |
| 2004/0107165 | June 2004 | Blair et al |
| 2004/0117302 | June 2004 | Weichert et al |
| 2004/0153398 | August 2004 | Baumgartner et al |
| 2004/0231018 | November 2004 | Olson |
| 2005/0246268 | November 2005 | Foran et al |

### DESCRIPTION

This invention relates to methods and systems for creating escrow accounts, more particularly to “consumer-managed” escrow accounts whose funds ingress/egress per the instructions of the consumer. The definition of “escrow” is: “Money or property held in trust by a third party to be turned over to the grantee only upon fulfillment of a condition.” This invention relates to methods and systems for creating accounts such that the consumer's funds can be held in trust until a consumer-defined condition is met after which the appropriate funds are released to the expected grantee (the recipient).

### BACKGROUND OF THE INVENTION

On many occasions individuals set funds aside for future expenditures. The manner and purpose fall into two categories: safe-keeping and immediate-need which are further described in the following two paragraphs.

Safe-Keeping:

The existing systems and methods for managing escrow accounts are well known. An individual will make a mortgage payment, a part of which is his annual insurance and/or property taxes which said amount is placed in escrow. These funds are held in trust by the mortgage company until the insurance premium and/or taxes are due, upon which the mortgage company remits the payment on behalf of the individual. Another example occurs during the sale of property wherein a binder is paid by the buyer, held in escrow by the realtor, then released to the seller (or returned to the buyer) at closing. Still another example exists wherein an individual buys a product online, places funds in escrow where they are held until the goods are received, and then the funds are released to the seller. Generally, an escrow account is established for either one of two reasons; to accumulate insurance and taxes as with the mortgage example, or to hold funds for a single purchase. In each case there are several drawbacks: the individual placing funds into the account has limited control over the funds once placed, the escrow account is limited to its singular purpose (i.e. holding funds for a specific transaction), and the individual cannot manage the escrow account funds to meet his needs.

### Immediate Need:

Furthermore, the existing systems and methods for paying bills are well known. An individual can pay in person using cash, purchase a money order or cashiers check and send this tender to the biller, write a personal check, automatic draft from a checking account, use a debit or credit card, or utilize an online bill payment system. Each of these has its drawbacks: paying in cash requires the payer to drive to the biller's site which can be expensive, time consuming, and unsafe. Purchasing money orders and cashier's checks is costly and time consuming. A drawback to the existing art assumes that the individual has a bank account, and that the account contains sufficient funds on the due date. Another drawback is that these methods assume that the payer has accumulated the funds in sufficient amount at the time that the bill is due, and has the ability to use one of the aforementioned methods to pay. Another drawback is that the consumer, having access to his funds, may spend them all before the bill is due. An additional drawback is that when an automatic draft is the method used, the individual must allow access to his bank account where someone other than the individual “pulls” money from the account.

As noted previously, a Consumer-Managed Escrow Account may provide for funds to be set-aside by a consumer for future use. A Consumer-Managed Escrow Account may resemble a traditional bank account to an ordinary observer, but does not allow for consumer access to the funds. A Consumer-Managed Escrow Account may function like a traditional escrow account, but allows for direct consumer involvement concerning the disbursement of funds. Such an account may reduce costs for recipients in collections where the consumer has not set-aside funds for bill payment, for consumers where they are charged late fees, and insufficient funds fees from their financial institution. Furthermore, such an account would allow an individual to restrict access to this account by “pushing” funds to recipients, or at a minimum use this account of all or his automatic drafts, thus protecting access to his personal bank account.

For a recipient, a Custodial Agent, and a Financial Institution, a Consumer-Managed Escrow Account may provide revenue through fees such as a monthly account maintenance fee, or remittance fees, paid by consumers. Alternatives for the fee payee and fee payer may result in the Custodial Agent being the fee payee and the recipient or consumer being the fee payer. Further revenue may be generated from the “float” of funds held by a Custodial Agent on behalf of a consumer. According to an embodiment of the invention, interest may be earned on the balance of funds in a Consumer-Managed Escrow Account. Interest may be awarded to any of the participants such as a recipient, Custodial Agent, or consumer, or may be awarded to any other entity.

For a recipient, costs associated with collecting funds from a consumer may be greatly reduced. For consumers, costs associated with late payments and insufficient funds can be greatly reduced or eliminated.

Consumer Managed Escrow Accounts may be used to support a variety of needs. By way of example only, some benefits and consequences are:

Insurance: A consumer may benefit with lower premiums. A trade association has negotiated a special rate for its members provided that all association members pay electronically on the same day each month.

Automobile: A consumer may benefit by avoiding the negative consequences of late payments. The consequences of late payments may be that his vehicle is disabled by a Starter Interrupt system. And he may be charged late fees.

Rental: A consumer may benefit by having certain of his deposits (e.g. last month's rent) waived, and others spread out over a longer term since the landlord in assured of his payment. The consumer may also benefit by avoiding all late payment fees

Health Club: The consumer may benefit by having the health club draft funds for its monthly dues from the Consumer-Managed Escrow Account instead of from the consumer's personal bank account.

Savings: A consumer who does not have a personal savings account may benefit by being able to place funds into the Consumer-Managed Escrow Account, allowing them to accumulate until needed.

It would therefore be advantageous to have a method and system allowing the consumer to establish an escrow account that addresses the shortcomings described above. It would be an advantage to provide a method and system allowing the consumer to control the adding of funds to his escrow account, but without having direct access to the funds, thereby accumulating funds until needed. It would be advantageous to enable the consumer to control the removing of funds from his escrow account, thereby paying out to the appropriate recipients according to his priority and direction. A further advantage would be to enable consumers who otherwise do not have bank accounts to have access to their own escrow account to overcome the shortcomings as described above.

These and other drawbacks exist to the aforementioned alternatives.

### SUMMARY

The object of the invention is to overcome these and other drawbacks in existing escrow account and bill payment methods, processes, and schemes.

A further objective of the invention is to provide a Consumer-Managed Escrow Account which allows the consumer to direct the addition of funds to the Consumer-Managed Escrow Account.

A further objective of the invention is to provide a Consumer-Managed Escrow Account which allows the consumer to direct the remittance of funds from the Consumer-Managed Escrow Account to a recipient.

A further objective of the invention is to provide a Consumer-Managed Escrow Account which can replace the need to pay bills by cash, money order, cashier's check, check, automatic draft, debit card, credit card, and online bill payment.

A further objective of the invention is to provide a Consumer-Managed Escrow Account which does not allow the consumer ready-access to the funds, thus promoting his ability to accumulate funds for off-schedule payments.

A further objective of the invention is to provide a Consumer-Managed Escrow Account which allows the consumer to accumulate funds for long-term (i.e. annual) needs.

These and other objects of the invention are accomplished according to the various embodiments of the invention. One of the embodiments of the invention provides a method of creating a Consumer-Managed Escrow Account, providing access and control of the Consumer-Managed Escrow Account to the consumer, whereby the Consumer-Managed Escrow Account is funded at the direction of the consumer, and funds are distributed to recipients at the discretion of the consumer. In this embodiment the account's funds are kept separate from all other account's funds. The consumer cannot directly (i.e. cash a check, get cash at an ATM, get cash at bank teller) access the funds, but can indirectly access the funds if the consumer directs that he is a recipient to be paid similar to all other recipients.

Another embodiment of the invention provides a system for creating and managing the Consumer-Managed Escrow Account. The system may comprise a processor for creating an account in a database. A consumer may provide instructions for the processor to fund the account.

Other objects and advantages exist for the present invention.

### BRIEF DESCRIPTION OF THE DRAWINGS

FIG. 1 shows a flowchart for requesting and creating a Consumer-Managed Escrow Account of an embodiment of the invention.

FIG. 2 illustrates a schematic of an embodiment of a system to be used with a Consumer-Managed Escrow Account.

### DETAILED DESCRIPTION OF THE DRAWINGS

The present invention is described in relation to a Consumer-Managed Escrow Account created for a consumer. In this environment, the present invention provides a Consumer-Managed Escrow Account that is funded by a plurality of systems and means as initiated by the consumer. The consumer may deposit funds to the account and receive information about the account, but may not withdraw funds from the account. Nonetheless, the characteristics and parameters of the Consumer-Managed Escrow Account are equally applicable to other accounts.

For purposes of explaining the present invention, an embodiment of the present invention is set forth. A Consumer-Managed Escrow Account may be used by a consumer to replace escrow accounts and/or personal depository accounts. A Consumer-Managed Escrow Account may be created and issued to each consumer who requests an account. Each Consumer-Managed Escrow Account may have its funds held separately from all other accounts, or may have its funds held separately as sub-accounts which are correlated to a master account, or may have its funds held together in a Custodial Account.

The consumer may fund the Consumer-Managed Escrow Account at periodic intervals such as those corresponding to the consumer's payday (e.g., every Friday, every other Friday, the last day of the month, etc.) by instructing his employer to fund the Consumer-Managed Escrow Account. The consumer may also fund the Consumer-Managed Escrow Account at irregular periods such as those corresponding to the consumer receiving cash awards, gifts, tax refunds, etc. by other methods including, but not limited to initiating a Direct Deposit via the Automated Clearinghouse (ACH), a wire transfer, a cash deposit at a teller window, or other approved money transfer methods. The consumer may initiate remittance of the funds to recipients at the consumer's discretion, through known manners of remittance, e.g., automatic draft, bill payment software, as well as through pre-defined instructions to the Custodial Agent. A consumer may obtain the balance of the Consumer-Managed Escrow Account, but may not directly withdraw funds from the account. The present invention will now be described in more detail.

According to an embodiment of the invention, a Consumer-Managed Escrow Account is an account into which the consumer may place or initiate the placement of funds, and may access other information associated with the account, such as the balance of the account and the transactions that have occurred in connection with the account. A consumer may initiate the withdrawal of funds from the account, may determine the details of the withdrawal, e.g. the amount, date, and recipient of the withdrawal, and may access other information associated with the account, including the balance in the account and various transactions that have occurred with the account.

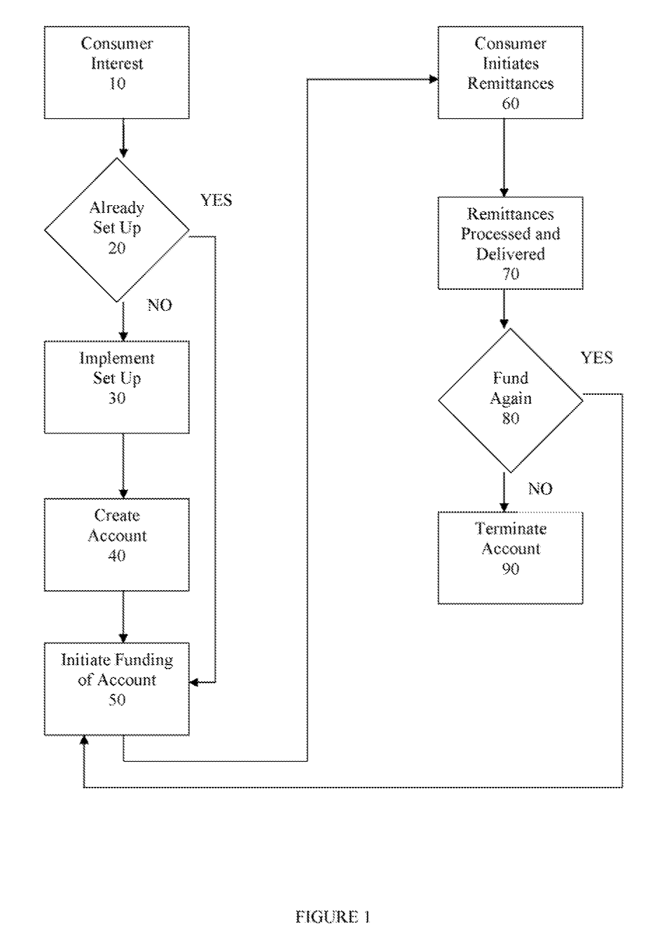

FIG. 1 illustrates a flow chart for creating and issuing a Consumer-Managed Escrow Account according to an embodiment of the invention. According to an embodiment, a consumer may become interested in acquiring a Consumer-Managed Escrow Account at step 10. Interest may be generated by advertising, such as radio and television commercials, internet advertisements, or direct mailing solicitation, such as through regular mail or through e-mail. Interest may also be generated through previous relationship with an escrow agent, bill payment provider, or service provider, such as having previously had bills paid through an escrow account, or participating in other payment methods offered by these providers. Other methods for interesting potential consumers may also be used.

A Custodial Agent may determine if a consumer has previously requested the creation and issuance of a Consumer-Managed Escrow Account at step 20. If a consumer has previously implemented a Consumer-Managed Escrow Account, the consumer may initiate account funding at step 50. If a consumer has not previously implemented a Consumer-Managed Escrow Account, the consumer may initiate the implementation of a Consumer-Managed Escrow Account at step 30. Various applications of a Consumer-Managed Escrow Account may include accumulating funds in the Consumer-Managed Escrow Account for future payments for insurance, property taxes, annual dues and fees, or other applications. Examples of other applications will be described in greater detail within this document.

A Custodial Agent may assist in implementing the Consumer-Managed Escrow Account set up request at Step 30. Implementation of a Consumer-Managed Escrow Account may include ensuring that applicable government regulations are properly followed, providing interface access between the appropriate mechanisms of all parties, e.g. consumer, Custodial Agent, bank, recipients, and ensuring that a consumer has the appropriate hardware and software to enable interaction with the other parties as may be necessary. Other implementation may also be required.

A consumer may request that a Consumer-Managed Escrow Account be created as a part of step 30. A request may be a written request, such as through sending a letter or by completing a written form, an oral request, such as by a telephone call or by an in-person request, or by an electronic request, such as by e-mail or through a web-site request. According to an embodiment of the invention, security procedures may be used to ensure that the Consumer-Managed Escrow Account is properly requested. Other methods for requesting creation of a Consumer-Managed Escrow Account may also be used.

The Custodial Agent creates an account at step 40. The account holds the funds designated by the consumer. The account may be a designated and/or defined as a master account, a correlation account, custodial accounts, single/individual accounts, funding/activity accounts, or other account at the discretion of the Custodial Agent. A consumer may initiate the addition of funds at step 50. According to an embodiment of the invention, a consumer may add funds to the account as desired, such as by Direct Deposit via ACH, wire transfer, cash deposit, and transferring funds from another account. Other methods for funding a Consumer-Managed Escrow Account may be used.

Issuing a Consumer-Managed Escrow Account may be performed in a number of known manners. These manners include mailing a notice to a consumer, or presenting a Consumer-Managed Escrow Account to the consumer in person, such as at the financial institution or at a place of business. Other methods for issuing a Consumer-Managed Escrow Account may also be used.

A Consumer-Managed Escrow Account may be given a unique account number which may be printed or embossed on a notice or an account identification card along with a consumer's name, as well as funding instructions. A Consumer-Managed Escrow Account may also be affiliated with financial institutions, debit and credit networks, bill presentment and payment providers, and businesses. Identification indicia of one or any of these affiliated entities may be displayed on the notice or card, as well as identification indicia of the Custodial Agent.

A consumer may initiate remittance of the funds at step 60. The consumer may initiate a remittance by supplying key information that is used to trigger the remittance event. The information may include: the recipient, an identifying payee account number, the amount to be sent, the date to send the funds, and other information as required. The consumer may not directly access the funds in the account by way of traditional, known means such as withdrawing funds as cash at an ATM terminal, making a POS purchase at a merchant transferring the funds to another account, or withdrawing funds at a financial institution. No other method of accessing funds may be used. Disallowing access to Consumer-Managed Escrow Account funds by the consumer solves a shortcoming of existing art wherein there are insufficient funds at the time of need. The consumer may indirectly access the funds by establishing himself as a recipient in a manner similar to any other recipient. Allowing the consumer to be a recipient is done so that the consumer may treat a portion of the funds for personal savings for future needs.

Remittances are processed and delivered at step 70 based on the information supplied in Step 60. The Custodial Agent uses the information provided in Step 60 to determine disbursement procedures for each Consumer-Managed Escrow Account. Funds not distributed remain in the Consumer-Managed Escrow Account. The funds may be distributed in any method available to the Custodial Agent such as wire transfer, ACH, check, or any other.

A consumer may determine whether to add additional funds to a Consumer-Managed Escrow Account at step 80. According to an embodiment of the invention, a consumer may add additional funds to the account using the consumer's desired method, such as by Direct Deposit via ACH, wire transfer, cash deposit, and transferring funds from another account. Other methods for funding a Consumer-Managed Escrow Account may be used. The consumer may add additional funds on a regular basis, such as with a payroll deduction or deposit, or may do so sporadically.

By way of example, a consumer elects to add additional funds via payroll direct deposit (DDP). The DDP includes a routing/transit number, a Consumer-Managed Escrow Account number, and an amount. The DDP is sent through the ACH. The DDP is sent to system 100, where it is processed as a credit to the appropriate Consumer-Managed Escrow Account in processing module 110.

If no funding of the Consumer-Managed Escrow Account is to take place, the Consumer-Managed Escrow Account may be terminated at step 90.

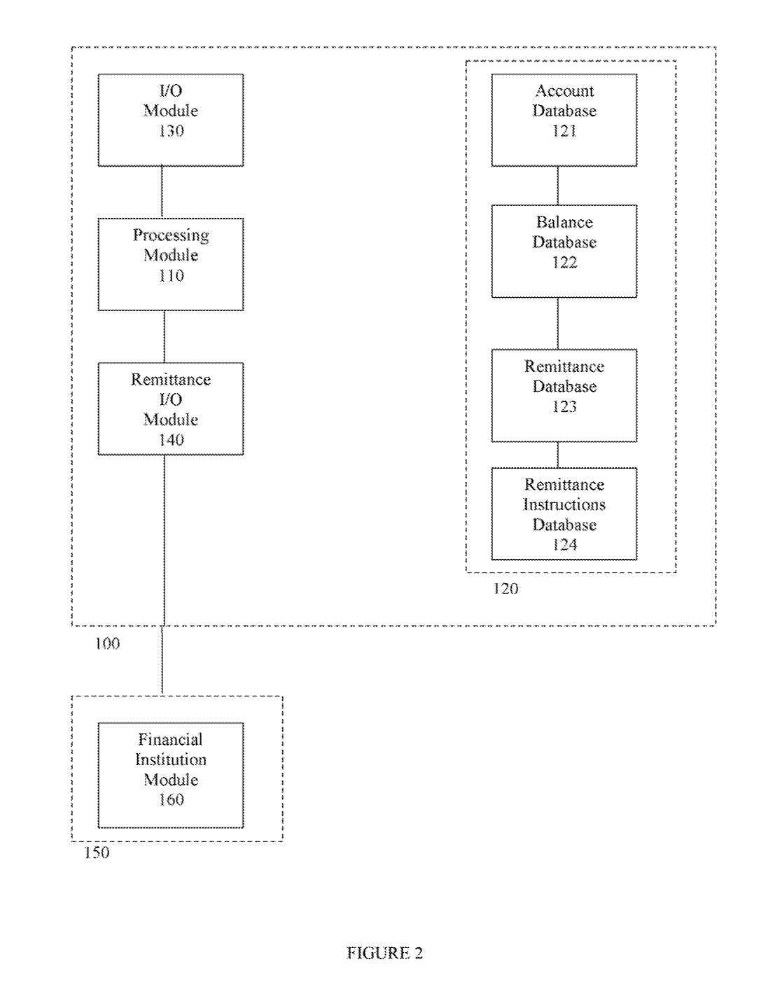

FIG. 2 illustrates a schematic system to support a Consumer Managed Escrow Account according to an embodiment of the invention. System 100 comprises a processing module 110, a database module 120, an input/output (I/O) module 130, and a remittance I/O module 140.

According to an embodiment of the invention, processing module 110 may act to coordinate information flow in system 100 and, according to an embodiment of the invention, may be a central processing unit (CPU) of a computer. According to an embodiment of the invention, database module 120 may comprise an account database module 121, a balance database module 122, a remittance database module 123, and a remittance instructions database module 124. An account database module 121 may be responsible for storing information related to accounts associated with each Consumer-Managed Escrow Account, such as an account number and the name of the accountholder. Other information may also be stored in an account database module 121.

Balance database module 122 may be responsible for storing information about the account balance. Processing module 110 may instruct balance database module 122 to be updated to increase or decrease the amount of funds in a Consumer-Managed Escrow Account. Funds may be increased when a consumer seeks to deposit funds into an account. Funds may be decreased if a consumer initiates remittance to a recipient, or if an event triggers a remittance to a recipient. Other information may also be stored in balance database module 122.

Remittance database module 122 may be responsible for storing information related to Consumer-Managed Escrow Account and Consumer-Managed Escrow Account remittances. According to an embodiment of the invention, remittance module 123 may maintain records of every deposit and remittance associated with a Consumer-Managed Escrow Account. A list of the remittances may be available to a consumer, and/or to a Custodial Agent. A list of remittances may be available in a hard copy, e.g., a print-out, or in a softcopy, e.g., an electronic medium such as a spreadsheet file. Other information may also be stored in the remittance database module 123.

Remittance Instructions database module 124 may be responsible for storing information about various remittance instructions, including the events that trigger as remittance, the identity of the recipient, the number of remittances to be made, the amount of the remittances, and the status of the remittances. According to an embodiment of the invention, a remittance information database module 124 may maintain records of information about each remittance, the Consumer-Managed Escrow Account associated with each remittance, and any instructions associated with each remittance. Other information may also be stored in remittance information database module 124.

Input/Output (I/O) module 130 may permit a consumer or Custodial Agent, collectively a User, to connect with processing module 110, and transmit and receive information. According to an embodiment of the invention, a User may use I/O module 130 to request information about one or more Consumer-Managed Escrow Accounts. Processing module 110 may access account database module 121, retrieve the requested information, and transmit the information to a User via I/O module 130. A User may also transmit a request for a new Consumer-Managed Escrow Account via I/O module 130. Other information may also be transmitted and/or requested. I/O module 130 may be a direct network connection, such as a dedicated line, or an indirect connection such as through the internet (World Wide Web) and a browser. Other methods of connection may also be used.

Remittance I/O module 140 may be connected to a financial institution 160 through System 150. A remittance instruction in module 124, through processing modules 100 and 150, may initiate a withdrawal of funds from a financial institution 160, from a Consumer-Managed Escrow Account by withdrawing funds in the form of a check, or transferring funds. Other methods of performing remittances may also be used.

As noted previously, a Consumer-Managed Escrow Account may provide for funds to be set-aside by a consumer for future use. According to an embodiment of the invention, a Consumer-Managed Escrow Account may resemble a traditional bank account to an ordinary observer, but with no consumer access, and may function like a traditional escrow account, but with direct consumer involvement concerning the disbursement of funds. Such an account may reduce costs for recipients in collections where the consumer has not set-aside funds for bill payment, for consumers where they are charged late fees by the recipient and insufficient funds fees from their financial institution. Further, the nature of the Consumer-Managed Escrow Account as described herein provides for the consumer to “push” funds to the recipient and restricts the recipient's ability to “pull” (i.e. draft) from the consumer's account.

For a recipient, a Custodial Agent, and a Financial Institution, a Consumer-Managed Escrow Account may provide revenue through fees such as a monthly account maintenance fee, or remittance fees, paid by consumers. Alternatives for the fee payee and fee payer may result in the Custodial Agent being the fee payee and the recipient or consumer being the fee payer. Further revenue may be generated from the “float” of funds held by a Custodial Agent on behalf of a consumer. According to an embodiment of the invention, interest may be earned on the balance of funds in a Consumer-Managed Escrow Account. Interest may be awarded to any of the participants such as a recipient, Custodial Agent, or consumer, or may be awarded to any other entity.

For a recipient, costs associated with collecting funds from a consumer may be greatly reduced. For consumers, costs associated with late payments and insufficient funds can be greatly reduced or eliminated.

Consumer-Managed Escrow Accounts may be used to support a variety of needs, including: (1) insurance payments; (2) automobile payments; (3) rent payments; (4) tax payments, (5) health club; and (6) personal savings.

According to an embodiment of the invention, a (1) insurance premium payment may allow a consumer to fund a Consumer-Managed Escrow Account and establish remittance instructions. The Consumer-Managed Escrow Account may be funded on a regular basis (i.e. weekly) allowing funds to accumulate until the premium is due (e.g. quarterly), at which time the remittance is “pushed” to the insurance carrier per the consumer's instructions. By way of example only, a trade association has negotiated a special rate for its members provided that all association members pay electronically on the same day each month.

According to an embodiment of the invention, a (2) automobile payments allow an individual to fund a Consumer-Managed Escrow Account and establish remittance instructions. The Consumer-Managed Escrow Account may be funded on a regular basis (i.e. weekly) allowing funds to accumulate until the payment is due (e.g. monthly), at which time the remittance is fulfilled. The remittance may be fulfilled by being “pushed” to the recipient or may be “pulled” by the recipient or a third-party per the consumer's instructions. As noted earlier, in certain segments of the auto industry, Starter Interrupt systems are used to disable the use of a vehicle if the payment is not paid on time.

According to an embodiment of the invention, a (3) rental payments allow an individual to fund a Consumer-Managed Escrow Account and establish remittance instructions. The Consumer-Managed Escrow Account may be funded on a regular basis (i.e. weekly) allowing funds to accumulate until the payment is due (e.g. monthly), at which time the remittance is fulfilled. The remittance may be fulfilled by the methods described in (1) and (2) above. As noted earlier, because the consumer has no access to these funds, the landlord may elect to spread certain deposits and fees over time.

A (4) tax payment application may allow consumers to use the Consumer-Managed Escrow Account for payment of structured settlements to the taxing authorities, or to set aside funds for estimated taxes. According to an embodiment of the invention, a consumer may need to set aside funds to pay regular structured settlement payments, or to pay periodic estimated taxes. The invention allows the consumer to set funds aside in a Consumer-Managed Escrow Account, establish instructions for remittance to the taxing authorities, and be confident that (a) the funds will be available when due, and (b) the funds will be remitted in a timely fashion.

A (5) health club application allows an individual to fund a Consumer-Managed Escrow Account and establish remittance instructions such that the health club may “pull” funds for its monthly dues from the Consumer-Managed Escrow Account as if it were drafting these funds from the consumer's personal bank account, but without the consumer's personal bank account being at risk.

According to an embodiment of the invention, a (6) savings application allows the consumer to place funds into the Consumer-Managed Escrow Account that are not allocated to the payment of a specific purpose. Said funds will remain in the Consumer-Managed Escrow Account until the consumer needs these funds. By way of an example only, the consumer does not have a bank account, but desires to set aside funds on a regular basis for future use to purchase a large item purchase or for a vacation.

According to a specific embodiment of the present invention, system 100 may comprise components of a software system. System 100 may operate on a network and be connected to other systems sharing a common database or databases. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for creating a Consumer-Managed Escrow Account, the method comprising;
creating one account wherein the consumer directs funds into said account and the account is independent and unassociated with any other account; and
the funds of said account are held independent of funds of all other accounts; and
issuing the account to the consumer; wherein;
a) the consumer is able to fund the account through a plurality of sources and means; and
b) the consumer is able to direct the disbursement of said funds through an escrow agent (“Custodial Agent”) to a plurality of recipients; and
c) the consumer is able to disburse funds from the account through a plurality of processes and means; and
d) the consumer is able to disburse funds to a plurality of recipients; and
e) the consumer is not able to directly access the account or its funds for personal use.

2. A system for creating a Consumer-Managed Escrow Account (“Consumer-Managed Escrow Account”), the system comprising;
creating one account wherein the consumer directs funds into said account and the account is independent and unassociated with any other account; and
the funds of said account are held independent of funds of all other accounts; and
issuing the account to the consumer; wherein;
f) the consumer is able to fund the account through a plurality of sources and means; and
g) the consumer is able to direct the disbursement of said funds through an escrow agent (“Custodial Agent”) to a plurality of recipients; and
h) the consumer is able to disburse funds from the account through a plurality of processes and means; and
i) the consumer is able to disburse funds to a plurality of recipients; and
j) the consumer is not able to directly access the account or its funds for personal use.
